(19) United States
(12) Patent Application Publication
(10) Pub. No.: US 2019/0200215 A1
(43) Pub. Date: Jun. 27, 2019

(54) Method for Migrating Data and Terminal

(71) Applicant: Guangdong Oppo Mobile Telecommunications Corp., Ltd., Dongguan (CN)

(72) Inventor: Zhifeng Ma, Dongguan (CN)

(21) Appl. No.: 16/291,779

(22) Filed: Mar. 4, 2019

Related U.S. Application Data
(63) Continuation of application No. PCT/CN2017/092243, filed on Jul. 7, 2017.

(30) Foreign Application Priority Data
Sep. 14, 2016 (CN) 201610825434.4

(51) Int. Cl. H04W 8/24; H04W 12/06; H04W 76/11; H04W 4/80; H04W 88/04

(52) U.S. Cl. CPC H04W 8/24; H04W 12/0608; H04W 88/04; H04W 4/80; H04W 76/11

(57) ABSTRACT

A method for migrating data and a terminal are provided. The method includes the following. A communication connection to a terminal is established. First data in data to be migrated is determined. The first data carrying first decryption information is transmitted to the terminal, where the first decryption information is configured to be matched with second decryption information acquired by the terminal.

### CROSS-REFERENCE TO RELATED APPLICATION(S)

This application is a continuation of International Application No. PCT/CN2017/092243, filed on Jul. 7, 2017, which claims priority to Chinese Patent Application No. 201610825434.4, filed on Sep. 14, 2016, the entire disclosures of both of which are hereby incorporated by reference in their entireties.

### TECHNICAL FIELD

The present disclosure relates to the technical field of terminals, and more particularly to a method for migrating data and a terminal.

### BACKGROUND

As terminal technologies advance rapidly, mobile phones have become an indispensable part of people's life. As people change their mobile phones faster and faster, how to transfer user data (such as daily-used applications, important chat records and documents, all Wi-Fi passwords, and the like) in an old mobile phone to a new mobile phone quickly and efficiently has become a technical problem to be solved.

### SUMMARY

A method for migrating data and a terminal are provided according to aspects of the present disclosure.

In a first aspect of the present disclosure, a method for migrating data is provided. The method includes the following.

A communication connection to a terminal is established. First data in data to be migrated is determined. The first data carrying first decryption information is transmitted to the terminal, the first decryption information is configured to be matched with second decryption information acquired by the terminal.

In a second aspect of the present disclosure, a method for migrating data is provided. The method includes the following.

A communication connection to a terminal is established. First data carrying first decryption information is received. Second decryption information is acquired. The first data is analyzed when detecting that the second decryption information matches the first decryption information.

In a third aspect of the present disclosure, a terminal is provided. The terminal includes at least one processor and a computer readable storage. The computer readable storage is coupled to the at least one processor and stores at least one computer executable instruction thereon which, when executed by the at least one processor, causes the at least one processor to carry out actions, including: establishing a communication connection to a terminal; determining first data in data to be migrated; and transmitting the first data carrying first decryption information to the terminal, the first decryption information being configured to be matched with second decryption information acquired by the terminal.

### BRIEF DESCRIPTION OF DRAWINGS

To describe technical solutions in aspects of the present disclosure or in the related art more clearly, the following briefly introduces the accompanying drawings required for describing the aspects or the related art. The accompanying drawings in the following description illustrate some aspects of the present disclosure. Those of ordinary skill in the art may also obtain other drawings based on these accompanying drawings without creative efforts.

FIG. 1 is a diagram illustrating network architecture according to an aspect of the present disclosure.

FIG. 2 is a flow chart illustrating a method for migrating data according to an aspect of the present disclosure.

FIG. 3 is a flow chart illustrating a method for migrating data according to an aspect of the present disclosure.

FIG. 4 is a flow chart illustrating a method for migrating data according to an aspect of the present disclosure.

FIG. 5 is a flow chart illustrating a method for migrating data according to another aspect of the present disclosure.

FIG. 6 is a flow chart illustrating a method for migrating data according to yet another aspect of the present disclosure.

FIG. 7 is a block diagram illustrating units of an apparatus for migrating data according to an aspect of the present disclosure.

FIG. 8 is a block diagram illustrating a terminal according to an aspect of the present disclosure.

FIG. 9 is a block diagram illustrating a terminal according to another aspect of the present disclosure.

### DETAILED DESCRIPTION

In order to enable those skilled in the art to better understand solutions of the present disclosure, technical solutions in aspects of the present disclosure will be described clearly and completely hereinafter with reference to the accompanying drawings in the aspects of the present disclosure. Apparently, the described aspects are merely some rather than all aspects of the present disclosure. All other aspects obtained by those of ordinary skill in the art based on the aspects of the present disclosure without creative efforts shall fall within the protection scope of the present disclosure.

The terms “first”, “second”, and the like used in the specification, the claims, and the accompany drawings of the present disclosure are used to distinguish different objects rather than describe a particular order. The terms “include”, “comprise”, and “have” as well as variations thereof are intended to cover non-exclusive inclusion. For example, a process, method, system, product, or apparatus including a series of steps or units is not limited to the listed steps or units, on the contrary, it can optionally include other steps or units that are not listed; alternatively, other steps or units inherent to the process, method, product, or device can be included either.

The term “aspect” appearing in various places in the specification does not necessarily refer to the same implementation, nor does it refer to an independent or alternative implementation that is mutually exclusive with other implementations. It is explicitly and implicitly understood by those skilled in the art that an implementation described herein may be combined with other implementations.

According to a method for migrating data provided in aspects of the present disclosure, a first terminal first establishes a communication connection to a second terminal, and then determines privacy data and system data in data to be migrated, where the data to be migrated includes the privacy data and the system data. Thereafter the first terminal transmits the system data and the privacy data carrying first decryption information to the second terminal, whereby the second terminal acquires second decryption information inputted by a user and analyzes the privacy data when the second terminal detects that the second decryption information matches the first decryption information. As can be seen, before migrating data, the first terminal will classify the data to be migrated. Specifically, the first terminal can migrate the system data directly and encrypt the privacy data. Accordingly, the second terminal needs to decrypt the privacy data after receiving the privacy data encrypted, then the privacy data received can be displayed or installed on the second terminal, which is beneficial to improving the security of data migration of a terminal.

In order to better understand the method and an apparatus for migrating data, aspects of the present disclosure will be described in detail below.

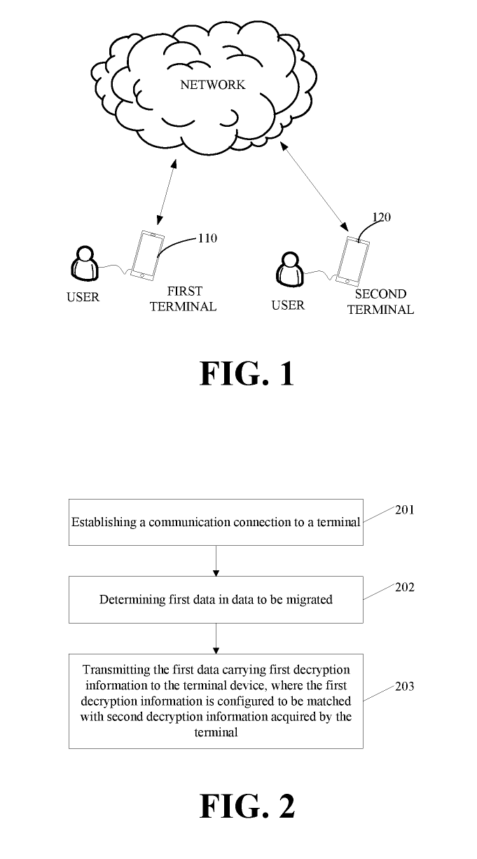

In order to better understand the method for migrating data and the terminal, network architecture applicable to the aspects of the present disclosure will be described in detail below. FIG. 1 is a diagram illustrating network architecture according to an aspect of the present disclosure. As illustrated in FIG. 1, the network architecture relates to a first terminal 110 and a second terminal 120. It should be noted that, the first terminal 110 and the second terminal 120 provided herein can be any terminal, such as a mobile phone, a tablet computer, a personal digital assistant (PDA), a point of sale terminal (POS), an on-board computer, and the like. The first terminal 110 may establish a communication connection with the second terminal 120 via a network. The first terminal 110 is configured to establish the communication connection to a second terminal, to determine privacy data in data to be migrated, and to transmit the privacy data carrying first decryption information to the second terminal. The second terminal is configured to acquire second decryption information inputted by a user and to analyze the privacy data received when detecting that the second decryption information matches the first decryption information.

Based on the network architecture illustrated in FIG. 1, a method for migrating data is provided in aspects of the present disclosure. FIG. 2 is a flow chart illustrating a method for migrating data according to an aspect of the present disclosure. The method is applicable to a terminal such as the first terminal 110 illustrated in FIG. 1. As illustrated in FIG. 2, the method begins at block 201.

At block 201, a communication connection to a terminal is established.

At block 202, first data in data to be migrated is determined.

At block 203, the first data carrying first decryption information is transmitted to the terminal, where the first decryption information is configured to be matched with second decryption information acquired by the terminal (in other words, whereby the terminal acquires second decryption information and analyzes the first data when the terminal detects that the second decryption information matches the first decryption information).

As can be seen, before migrating data, the data to be migrated is classified so that the first data in the data to be migrated is determined and encrypted. Accordingly, the terminal needs to decrypt the first data after receiving the first data encrypted, then the first data can be displayed or installed on the terminal, which can improve the security of data migration of a terminal.

In an aspect, the first data carrying the first decryption information is transmitted to the terminal as follows.

The first decryption information pre-stored is acquired. The first data carrying the first decryption information pre-stored is transmitted to the terminal.

In an aspect, the first data carrying the first decryption information is transmitted to the terminal as follows.

A decryption information setting interface is displayed on a display interface. The first decryption information inputted via the display interface is acquired. The first data carrying the first decryption information is transmitted to the terminal.

In an aspect, the communication connection to the terminal is established as follows.

A two-dimensional code containing a hotspot identity of a wireless hotspot and password information corresponding to the hotspot identity is displayed on a display interface, scanned by the terminal for the terminal to acquire the hotspot identity and the password information, the communication connection to the terminal is established based on the hotspot identity and the password information.

In an aspect, the communication connection to the terminal is established as follows.

The communication connection to the terminal is established based on a short-range wireless communication technology.

In an aspect, the short-range wireless communication technology includes at least one of: a near field communication (NFC) technology, a ZigBee technology, or a Bluetooth communication technology.

In an aspect, the method further includes the following.

Second data in the data to be migrated is determined. The second data is transmitted to the terminal.

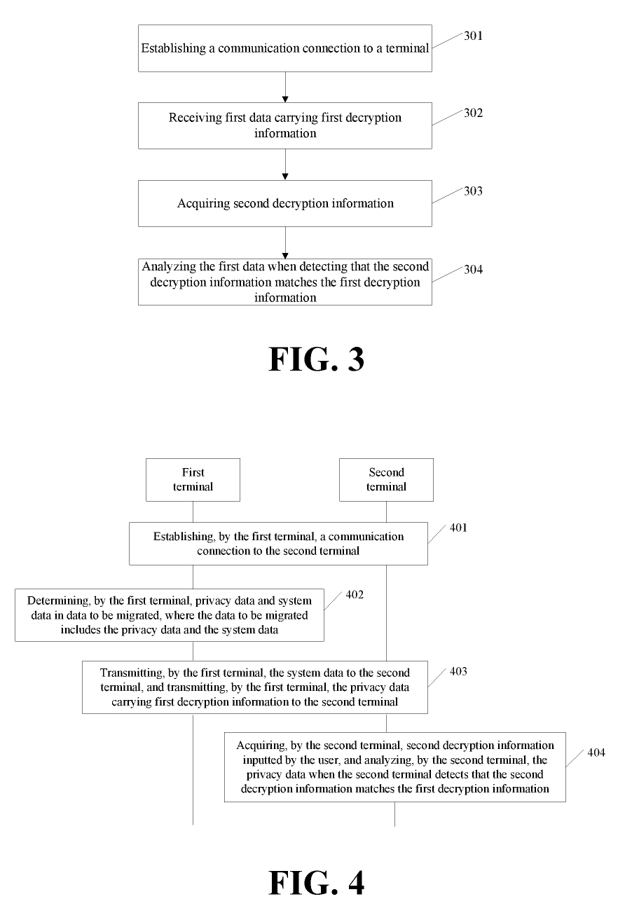

Based on the network architecture illustrated in FIG. 1, a method for migrating data is provided in aspects of the present disclosure. FIG. 3 is a flow chart illustrating a method for migrating data according to an aspect of the present disclosure. The method is applicable to a terminal such as the second terminal 120 illustrated in FIG. 1. As illustrated in FIG. 3, the method begins at block 301.

At block 301, a communication connection to a terminal is established.

At block 302, first data carrying first decryption information is received.

At block 303, second decryption information is acquired.

At block 304, the first data is analyzed when the second decryption information is detected to be matched with the first decryption information.

FIG. 4 is a flow chart illustrating a method for migrating data according to an aspect of the present disclosure. The method is applicable to the first terminal illustrated in FIG. 1. As illustrated in FIG. 4, the method begins at block 401.

At block 401, a first terminal establishes a communication connection to a second terminal.

In one aspect, the first terminal establishes the communication connection to the second terminal as follows.

The first terminal displays a two-dimensional code on a display interface of the first terminal. The two-dimensional code contains a hotspot identity of a wireless hotspot created by the first terminal and password information corresponding to the hotspot identity, and is used to be scanned by the second terminal to obtain the hotspot identity of the wireless hotspot created by the first terminal and the password information corresponding to the hotspot identity, to establish a communication connection with the first terminal based on the hotspot identity and the password information.

In one aspect, the first terminal establishes the communication connection to the second terminal as follows.

The first terminal acquires a hotspot identity of a wireless hotspot and password information corresponding to the hotspot identity by scanning a two-dimensional code displayed on a display interface of the second terminal. The first terminal establishes the communication connection based on the hotspot identity and the password information.

In one aspect, the first terminal establishes the communication connection to the second terminal as follows.

The first terminal establishes the communication connection to the second terminal based on a short-range wireless communication technology. The short-range wireless communication technology includes at least one of: a near field communication (NFC) technology, a ZigBee technology, or a Bluetooth communication technology.

At block 402, the first terminal determines privacy data (that is, first data) and system data (that is, second data) in data to be migrated, where the data to be migrated includes the privacy data and the system data.

The privacy data is data that the user are not willing to disclose, such as chat record, account and password of some applications, and the like.

In one aspect, the system data can be data other than the privacy data in the data to be migrated, such as an installation package of an application, some pictures, and the like.

At block 403, the first terminal transmits the system data to the second terminal, and transmits the privacy data carrying first decryption information to the second terminal.

In one aspect, the first terminal transmits the privacy data carrying the first decryption information to the second terminal as follows.

The first terminal acquires the first decryption information pre-stored, and transmits the privacy data carrying the first decryption information pre-stored to the second terminal based on the communication connection established with the second terminal.

In one aspect, the first terminal transmits the privacy data carrying the first decryption information to the second terminal as follows.

The first terminal displays a decryption information setting interface on a display interface of the first terminal and acquires the first decryption information inputted by a user. The first terminal transmits the privacy data carrying the first decryption information inputted by the user to the second terminal based on the communication connection established with the second terminal.

At block 404, the second terminal acquires second decryption information inputted by the user, and analyzes the privacy data when detecting that the second decryption information matches the first decryption information.

According to the method for migrating data provided in the aspects of the present disclosure, the first terminal first establishes the communication connection to the second terminal, and then determines the privacy data and the system data in the data to be migrated, where the data to be migrated includes the privacy data and the system data. Thereafter the first terminal transmits the system data and the privacy data carrying the first decryption information to the second terminal, whereby the second terminal acquires the second decryption information inputted by the user and analyzes the privacy data when the second terminal detects that the second decryption information matches the first decryption information. It can be seen that, before migrating data, the first terminal will classify the data to be migrated. The first terminal can migrate the system data directly and encrypt the privacy data. Accordingly, the second terminal needs to decrypt the privacy data after receiving the privacy data encrypted, then the privacy data can be displayed or installed on the second terminal, which can improve the security of data migration of a terminal.

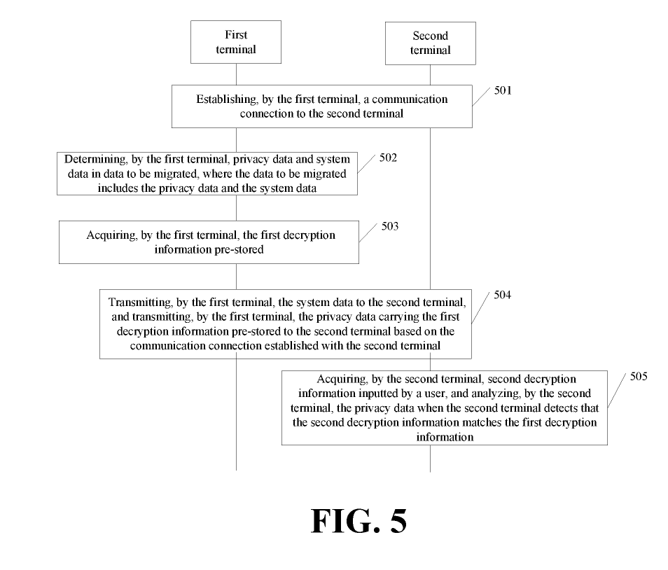

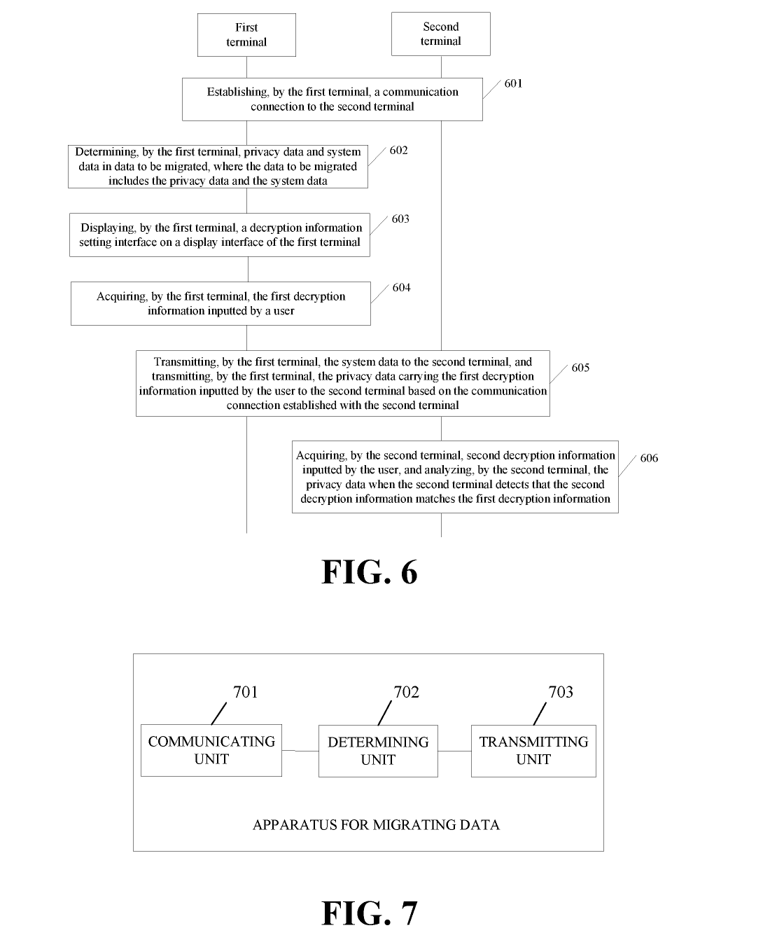

The first terminal can acquired the first decryption information in many different ways, which will be described in detail as illustrated in FIG. 5 and FIG. 6

FIG. 5 is a flow chart illustrating a method for migrating data according to another aspect of the present disclosure. The method can be implemented in the network architecture illustrated in FIG. 1. As illustrated in FIG. 5, the method begins at block 501.

At block 501, a first terminal establishes a communication connection to a second terminal.

In one aspect, the first terminal establishes the communication connection to the second terminal as follows.

The first terminal displays a two-dimensional code on a display interface of the first terminal. The two-dimensional code contains a hotspot identity of a wireless hotspot created by the first terminal and password information corresponding to the hotspot identity, and is used to be scanned by the second terminal to acquire the hotspot identity of the wireless hotspot created by the first terminal and the password information corresponding to the hotspot identity, to establish a communication connection with the first terminal based on the hotspot identity and the password information.

In one aspect, the first terminal establishes the communication connection to the second terminal as follows.

The first terminal establishes the communication connection to the second terminal based on a short-range wireless communication technology. The short-range wireless communication technology includes at least one of: an NFC technology, a ZigBee technology, or a Bluetooth communication technology.

At block 502, the first terminal determines privacy data and system data in data to be migrated, where the data to be migrated includes the privacy data and the system data.

At block 503, the first terminal acquires the first decryption information pre-stored.

At block 504, the first terminal transmits the system data to the second terminal, and transmits the privacy data carrying the first decryption information pre-stored to the second terminal based on the communication connection established with the second terminal.

At block 505, the second terminal acquires second decryption information inputted by a user and analyzes the privacy data when detecting that the second decryption information matches the first decryption information.

According to the method for migrating data provided in the aspects of the present disclosure, the first terminal first establishes the communication connection to the second terminal, and then determines the privacy data and the system data in the data to be migrated, where the data to be migrated includes the privacy data and the system data. Thereafter the first terminal acquires the first decryption information pre-stored and transmits the system data and the privacy data carrying the first decryption information to the second terminal, whereby the second terminal acquires the second decryption information inputted by the user and analyzes the privacy data when the second terminal detects that the second decryption information matches the first decryption information. It can be seen that, before migrating data, the first terminal will classify the data to be migrated. Specifically, the first terminal can migrate the system data directly and encrypt the privacy data. Accordingly, the second terminal needs to decrypt the privacy data after receiving the privacy data encrypted, then the privacy data received can be displayed or installed on the second terminal, it is possible to increase the security of data migration of a terminal.

FIG. 6 is a flow chart illustrating a method for migrating data according to yet another aspect of the present disclosure. The method can be implemented in the network architecture illustrated in FIG. 1. As illustrated in FIG. 6, the method begins at block 601.

At block 601, a first terminal establishes a communication connection to a second terminal.

In one aspect, the first terminal establishes the communication connection to the second terminal as follows.

The first terminal displays a two-dimensional code on a display interface of the first terminal. The two-dimensional code contains a hotspot identity of a wireless hotspot created by the first terminal and password information corresponding to the hotspot identity, and is used to be scanned by the second terminal to acquire the hotspot identity of the wireless hotspot created by the first terminal and the password information corresponding to the hotspot identity, to establish a communication connection with the first terminal based on the hotspot identity and the password information.

In one aspect, the first terminal establishes the communication connection to the second terminal as follows.

The first terminal establishes the communication connection to the second terminal based on a short-range wireless communication technology. The short-range wireless communication technology includes at least one of: an NFC technology, a ZigBee technology, or a Bluetooth communication technology.

At block 602, the first terminal determines privacy data and system data in data to be migrated, where the data to be migrated includes the privacy data and the system data.

At block 603, the first terminal displays a decryption information setting interface on a display interface of the first terminal.

At block 604, the first terminal acquires the first decryption information inputted by a user.

At block 605, the first terminal transmits the system data to the second terminal, and transmits the privacy data carrying the first decryption information inputted by the user to the second terminal based on the communication connection established with the second terminal.

At block 606, the second terminal acquires second decryption information inputted by the user, and analyzes the privacy data when detecting that the second decryption information matches the first decryption information.

According to the method for migrating data provided in the aspects of the present disclosure, the first terminal first establishes the communication connection to the second terminal, and then determines the privacy data and the system data in the data to be migrated, where the data to be migrated includes the privacy data and the system data. The first terminal displays the decryption information setting interface on the display interface of the first terminal and acquires the first decryption information inputted by the user. Thereafter the first terminal transmits the system data and the privacy data carrying the first decryption information to the second terminal, whereby the second terminal acquires the second decryption information inputted by the user and analyzes the privacy data when the second terminal detects that the second decryption information matches the first decryption information. As can be seen, before migrating data, the first terminal will classify the data to be migrated. Specifically, the first terminal can migrate the system data directly and encrypt the privacy data. Accordingly, the second terminal needs to decrypt the privacy data after receiving the privacy data encrypted, then the privacy data received can be displayed or installed on the second terminal, which can improve the security of data migration of a terminal.

Another aspect of the present disclosure is illustrated as follows. As illustrated in FIG. 7, an apparatus for migrating data is provided. The apparatus includes a communicating unit 701, a determining unit 702, and a transmitting unit 703.

The communicating unit 701 is configured to establish a communication connection to a second terminal.

The determining unit 702 is configured to determine privacy data and system data in data to be migrated, where the data to be migrated includes the privacy data and the system data.

The transmitting unit 703 is configured to transmit the system data to the second terminal, and to transmit the privacy data carrying first decryption information to the second terminal, whereby the second terminal acquires second decryption information inputted by a user and analyzes the privacy data when the second terminal detects that the second decryption information matches the first decryption information.

In an aspect, the transmitting unit 703 configured to transmit the privacy data carrying the first decryption information to the second terminal is configured to acquire the first decryption information pre-stored, and to transmit the privacy data carrying the first decryption information pre-stored to the second terminal based on the communication connection established with the second terminal.

In an aspect, the transmitting unit 703 configured to transmit the privacy data carrying the first decryption information to the second terminal is configured to display a decryption information setting interface on a display interface, to acquire the first decryption information inputted by the user, and to transmit the privacy data carrying the first decryption information inputted by the user to the second terminal based on the communication connection established with the second terminal.

In an aspect, the communicating unit 701 is configured to display a two-dimensional code on a display interface. The two-dimensional code contains a hotspot identity of a wireless hotspot created by a first terminal and password information corresponding to the hotspot identity, and is used to be scanned by the second terminal to obtain the hotspot identity of the wireless hotspot created by the first terminal and the password information corresponding to the hotspot identity, to establish a communication connection with the first terminal based on the hotspot identity and the password information.

In an aspect, the communicating unit 701 is configured to establish the communication connection to the second terminal based on a short-range wireless communication technology. The short-range wireless communication technology includes at least one of: an NFC technology, a ZigBee technology, or a Bluetooth communication technology.

It is to be noted that, the apparatus for migrating data described in the aspects of the disclosure is presented in the form of functional units. The term “unit” used herein should be understood as the broadest meaning as possible, and an object for implementing functions defined by each “unit” may be, for example, an application-specific integrated circuit (ASIC), a single circuit, a processor (shared, dedicated, or chipset) and a memory for executing one or more software or firmware programs, a combinational logic circuit, and/or other suitable components that can achieve the above described functions.

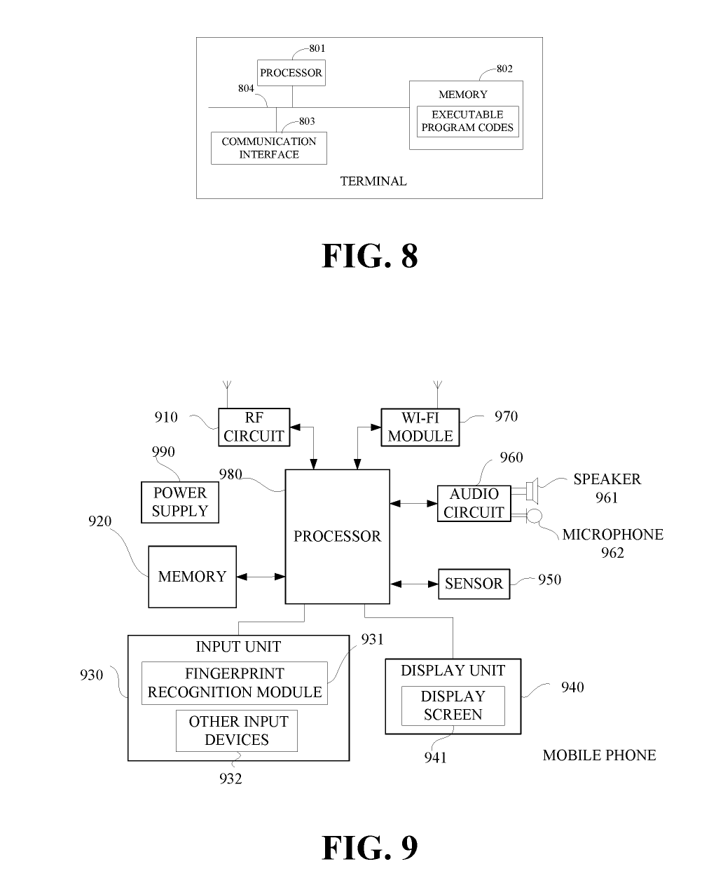

In an aspect, the function of the communication unit 701 to establish the communication connection to the second terminal can be implemented by a terminal illustrated in FIG. 8. The terminal may invoke executable program codes in a memory 802 through a processor 801 to establish the communication connection to the second terminal.

According to the apparatus for migrating data provided in the aspects of the present disclosure, the communication connection to the second terminal is first established, and then the privacy data and the system data in the data to be migrated is determined, where the data to be migrated includes the privacy data and the system data. Thereafter the system data and the privacy data carrying the first decryption information are transmitted to the second terminal, whereby the second terminal acquires the second decryption information inputted by the user and analyzes the privacy data when the second terminal detects that the second decryption information matches the first decryption information. It can be seen that, before migrating data, the data to be migrated will be classified. Specifically, the system data is migrated directly and the privacy data is encrypted. Accordingly, the second terminal needs to decrypt the privacy data after receiving the privacy data encrypted, then the privacy data received can be displayed or installed on the second terminal, which can improve the security of data migration of a terminal.

A terminal is further provided in the aspects of the present disclosure. As illustrated in FIG. 8, the terminal includes a processor 801, a memory 802, a communication interface 803, and a communication bus 804. The processor 801, the memory 802, and the communication interface 803 are coupled through the communication bus 804 and communicate with each other. The processor 801 is configured to control a wireless communication with an external cellular network via the communication interface 803. The communication interface 803 includes, but is not limited to, an antenna, an amplifier, a transceiver, a coupler, a low noise amplifier (LNA), a duplexer, and the like. The memory 802 includes at least one of a random-access memory (RAM), a non-volatile memory, and an external memory. The memory 802 is configured to store executable program codes. The executable program codes are applicable with the processor 801 to perform the method for migrating data according to the foregoing method aspects of the present disclosure, and the method includes the following.

The processor 801 establishes a communication connection to a second terminal.

The processor 801 determines first data (for example, privacy data) and second data (for example, system data) in data to be migrated, where the data to be migrated includes the privacy data and the system data.

The processor 801 transmits the system data to the second terminal, and transmits the privacy data carrying first decryption information to the second terminal, whereby the second terminal acquires second decryption information inputted by a user and whereby the second terminal analyzes the privacy data when the second terminal detects that the second decryption information matches the first decryption information.

In one aspect, the processor 801 transmits the privacy data carrying the first decryption information to the second terminal as follows.

The processor 801 acquires the first decryption information pre-stored. The processor 801 transmits the privacy data carrying the first decryption information pre-stored to the second terminal based on the communication connection established with the second terminal.

In one aspect, the processor 801 transmits the privacy data carrying the first decryption information to the second terminal as follows.

The processor 801 displays a decryption information setting interface on a display interface. The processor 801 acquires the first decryption information inputted by the user. The processor 801 transmits the privacy data carrying the first decryption information inputted by the user to the second terminal based on the communication connection established with the second terminal.

In one aspect, the processor 801 establishes the communication connection to the second terminal as follows.

The processor 801 controls a display interface to display a two-dimensional code. The two-dimensional code contains a hotspot identity of a wireless hotspot created by the processor 801 and password information corresponding to the hotspot identity, and is used to be scanned by the second terminal to acquire the hotspot identity of the wireless hotspot created by the processor 801 and the password information corresponding to the hotspot identity, to establish a communication connection with the processor 801 based on the hotspot identity and the password information.

In one aspect, the processor 801 establishes the communication connection to the second terminal as follows.

The processor 801 establishes the communication connection to the second terminal based on a short-range wireless communication technology. The short-range wireless communication technology includes at least one of an NFC technology, a ZigBee technology, and a Bluetooth communication technology.

According to the terminal provided in the aspects of the present disclosure, the communication connection to the second terminal is first established, and then the privacy data and the system data in the data to be migrated is determined, where the data to be migrated includes the privacy data and the system data. Thereafter the system data and the privacy data carrying the first decryption information are transmitted to the second terminal, whereby the second terminal acquires the second decryption information inputted by the user and analyzes the privacy data when the second terminal detects that the second decryption information matches the first decryption information. It can be seen that, before migrating data, the data to be migrated will be classified. Specifically, the system data is migrated directly and the privacy data is encrypted. Accordingly, the second terminal needs to decrypt the privacy data after receiving the privacy data encrypted, then the privacy data received can be displayed or installed on the second terminal, which can improve the security of data migration of a terminal.

The executable program codes stored in the memory 802 are further configured to perform the operations related to the methods for migrating data illustrated in FIG. 2, FIG. 3, and FIG. 4. In an aspect, the executable program codes are configured to perform the operations of transmitting the system data to the second terminal, and transmitting the privacy data carrying the first decryption information to the second terminal, whereby the second terminal acquires the second decryption information inputted by the user and analyzes the privacy data when the second terminal detects that the second decryption information matches the first decryption information.

Another terminal is provided according to an aspect of the present disclosure. As illustrated in FIG. 9, only parts related to the aspects of the present disclosure are illustrated for ease of description. For technical details not described, reference may be made to the method aspects of the present disclosure. The terminal may be any terminal, such as a mobile phone, a tablet computer, a PDA, a POS, an on-board computer, and the like. The following describes a mobile phone as an example of the terminal.

FIG. 9 is a block diagram of a part of a structure of a mobile phone related to a terminal according to an aspect of the present disclosure. As illustrated in FIG. 9, the mobile phone includes a radio frequency (RF) circuit 910, a memory 920, an input unit 930, a display unit 940, a sensor 950, an audio circuit 960, a Wi-Fi module 970, a processor 980, a power supply 990, and other components. Those skilled in the art can understand that the structure of the mobile phone illustrated in FIG. 9 does not constitute any limitation on a mobile phone. The mobile phone configured to implement technical solutions of the disclosure may include more or fewer components than illustrated or may combine certain components or different components.

In the following, various components of the mobile phone will be described in detail with reference to FIG. 9.

The RF circuit 910 is configured to transmit or receive information. Generally, the RF circuit 910 includes but is not limited to an antenna, at least one amplifier, a transceiver, a coupler, an LNA, a duplexer, and the like. In addition, the RF circuit 910 may also communicate with the network and other devices via wireless communication. The above wireless communication may use any communication standard or protocol, which includes but is not limited to global system of mobile communication (GSM), general packet radio service (GPRS), code division multiple access (CDMA), wideband code division multiple access (WCDMA), long term evolution (LTE), E-mail, short messaging service (SMS) and so on.

The memory 920 is configured to store software programs and modules, and the processor 980 is configured to execute various function applications and data processing of the mobile phone by running the software programs and the modules stored in the memory 920. The memory 920 mainly includes a program storage area and a data storage area. The program storage area may store an operating system, application programs required for at least one function and so on. The data storage area may store data created according to use of the mobile phone and so on. In addition, the memory 920 may include a high-speed RAM, and may further include a non-volatile memory such as at least one disk storage device, a flash device, or other non-volatile solid storage devices.

The input unit 930 may be configured to receive input digital or character information and to generate key signal input associated with user setting and function control of the mobile phone. In an aspect, the input unit 930 may include a fingerprint recognition module 931 and other input devices 932. The fingerprint recognition module 931 can collect fingerprint data of the user. In an aspect, the fingerprint recognition module 931 can include an optical fingerprint module, a capacitive fingerprint module, and an RF fingerprint module. The fingerprint recognition module 931 may be a capacitive fingerprint recognition module and may include a sensing electrode (an abnormal sensing electrode and a normal sensing electrode), and a signal processing circuit (such as an amplifying circuit, a noise suppression circuit, an analog digital converter (ADC) circuit, and the like) coupled with the sensing electrode. In addition to the fingerprint recognition module 931, the input unit 930 may further include other input devices 932. In an aspect, other input devices 932 may include, but are not limited to, one or more of a physical keyboard, a function key (such as a volume control key, a switch key, etc.), a trackball, a mouse, a joystick and the like.

The display unit 940 is configured to display information input by the user or information provided for the user or various menus of the mobile phone. The display unit 940 may include a display screen 941, and alternatively, the display screen 941 may be in the form of a liquid crystal display (LCD), an organic light-emitting diode (OLED) and so on. Although the fingerprint recognition module 931 and the display screen 941 are illustrated as two separate components in FIG. 9 to realize the input and output functions of the mobile phone, in some aspects, the fingerprint recognition module 931 may be integrated with the display screen 941 to achieve the input and output functions of the mobile phone.

The mobile phone may also include at least one sensor 950, such as a light sensor, a motion sensor, and other sensors. As one aspect, the light sensor may include an ambient light sensor and a proximity sensor, among which the ambient light sensor may adjust the brightness of the display screen 941 according to ambient lights, and the proximity sensor may turn off the display screen 941 and/or backlight when the mobile phone reaches nearby the ear. As a kind of motion sensor, the accelerometer sensor can detect the magnitude of acceleration in all directions (typically three axes) and when the mobile phone is stationary, the accelerometer sensor can detect the magnitude and direction of gravity; the accelerometer sensor can also identify mobile-phone gestures related applications (such as vertical and horizontal screen switch, related games, or magnetometer attitude calibration), or the accelerometer sensor can be used for vibration-recognition related functions (such as a pedometer, or percussion) and so on. The mobile phone can also be equipped with a gyroscope, a barometer, a hygrometer, a thermometer, infrared sensor, and other sensors, which will not be repeated herein.

The audio circuit 960, the speaker 961, the microphone 962 may provide an audio interface between the user and the mobile phone. The audio circuit 960 may convert the received audio data into electrical signals and transfer the electrical signals to the speaker 961; thereafter the speaker 961 converts the electrical signals into sound signals for output. On the other hand, the microphone 962 converts the received sound signals into electrical signals, which will be received and converted into audio data by the audio circuit 960 for output. The audio data is then processed and transmitted by the processor 980 via an RF circuit 910 to another mobile phone for example, or the audio data is output to the memory 920 for further processing.

Wi-Fi belongs to a short-range wireless transmission technology. With aid of a Wi-Fi module 970, the mobile phone may assist the user in E-mail receiving and sending, webpage browsing, access to streaming media, and the like. Wi-Fi provides users with wireless broadband Internet access. Although the Wi-Fi module 970 is illustrated in FIG. 9, the Wi-Fi module 970 is not essential to the mobile phone and can be omitted according to actual needs without departing from the essential nature of the present disclosure.

The processor 980 is the control center of the mobile phone and is configured to connect various parts of the whole mobile phone through various interfaces and lines, run or execute software programs and/or modules stored in the memory 920, and invoke data stored in the memory 920 to perform various functions of the mobile phone and process data, thereby monitoring the mobile phone as a whole. In at least one aspect, the processor 980 may include one or more processing units. For example, the processor 980 may integrate an application processor and a modem processor, where the application processor is configured to handle an operating system, a user interface, an application, and so on, and the modem processor is mainly configured to process wireless communication. It will be understood that the above-mentioned modem processor may not be integrated into the processor 980.

The mobile phone also includes the power supply 990 (e.g., a battery) that supplies power to various components. For instance, the power supply 990 may be logically connected to the processor 980 via a power management system to enable management of charging, discharging, and power consumption through the power management system.

Although not illustrated, the mobile phone may include a camera, a Bluetooth module, etc., and the disclosure will not elaborate herein.

The methods of the foregoing aspects illustrated in FIG. 2 to FIG. 6 can be realized based on the structure of the mobile phone.

The functions of the units illustrated in FIG. 7 can be achieved based on the structure of the mobile phone.

Aspects of the present disclosure also provide a computer storage medium. The computer storage medium stores computer programs which, when executed, are configured to execute all or part of the operations of any of the methods for migrating data described in the above-described method aspects.

It is to be noted that, for the sake of simplicity, the foregoing method aspects are described as a series of action combinations, however, it will be appreciated by those skilled in the art that the present disclosure is not limited by the sequence of actions described. According to the present disclosure, certain steps or operations may be performed in other order or simultaneously. Besides, it will be appreciated by those skilled in the art that the aspects described in the specification are exemplary aspects and the actions and modules involved are not necessarily essential to the present disclosure.

In the foregoing aspects, the description of each aspect has its own emphasis. For the parts not described in detail in one aspect, reference may be made to related descriptions in other aspects.

In the aspects of the disclosure, the apparatus disclosed in aspects provided herein may be implemented in other manners. For example, the device/apparatus aspects described above are merely illustrative; for instance, the division of the unit is only a logical function division and there can be other manners of division during actual implementations, for example, multiple units or components may be combined or may be integrated into another system, or some features may be ignored, omitted, or not performed. In addition, coupling or communication connection between each illustrated or discussed component may be direct coupling or communication connection, or may be indirect coupling or communication among devices or units via some interfaces, and may be electrical connection, mechanical connection, or other forms of connection.

The units described as separate components may or may not be physically separated, the components illustrated as units may or may not be physical units, that is, they may be in the same place or may be distributed to multiple network elements. All or part of the units may be selected according to actual needs to achieve the purpose of the technical solutions of the aspects.

In addition, the functional units in various aspects of the present disclosure may be integrated into one processing unit, or each unit may be physically present, or two or more units may be integrated into one unit. The above-mentioned integrated unit can be implemented in the form of hardware or a software function unit.

The integrated unit may be stored in a computer-readable memory when it is implemented in the form of a software functional unit and is sold or used as a separate product. Based on such understanding, the technical solutions of the present disclosure essentially, or the part of the technical solutions that contributes to the related art, or all or part of the technical solutions, may be embodied in the form of a software product which is stored in a memory and includes instructions for causing a computer device (which may be a personal computer, a server, or a network device and so on) to perform all or part of the steps described in the various aspects of the present disclosure. The memory includes various medium capable of storing program codes, such as a universal serial bus (USB) flash disk, a read-only memory (ROM), a RAM, a removable hard disk, a disk, a compact disc (CD), or the like.

It will be understood by those of ordinary skill in the art that all or a part of the various methods of the aspects described above may be accomplished by means of a program to instruct associated hardware, the program may be stored in a computer-readable memory, which may include a flash memory, a ROM, a RAM, a disk, a CD, and the like.

The aspects of the present disclosure are described in detail above, and the principles and aspects of the present disclosure are described herein by using specific aspects. The description of the above aspects is only for helping to understand the method and the technical solutions of the present disclosure. For those of ordinary skill in the art, there will be changes in specific implementations and applications according to the idea of the present disclosure. In conclusion, the content of the specification should not be understood as limiting the disclosure.

What is claimed is:

1. A method for migrating data, comprising:
establishing a communication connection to a terminal;
determining first data in data to be migrated; and
transmitting the first data carrying first decryption information to the terminal, wherein the first decryption information is configured to be matched with second decryption information acquired by the terminal.

2. The method of claim 1, wherein transmitting the first data carrying the first decryption information to the terminal comprises:
acquiring the first decryption information pre-stored; and
transmitting the first data carrying the first decryption information pre-stored to the terminal.

3. The method of claim 1, wherein transmitting the first data carrying the first decryption information to the terminal comprises:
displaying a decryption information setting interface on a display interface;
acquiring the first decryption information inputted via the display interface; and
transmitting the first data carrying the first decryption information to the terminal.

4. The method of claim 1, wherein establishing the communication connection to the terminal comprises:
displaying a two-dimensional code containing a hotspot identity of a wireless hotspot and password information corresponding to the hotspot identity on a display interface, scanned by the terminal to acquire the hotspot identity and the password information; and
establishing the communication connection to the terminal based on the hotspot identity and the password information.

5. The method of claim 1, wherein establishing the communication connection to the terminal comprises:
establishing the communication connection to the terminal based on a short-range wireless communication technology.

6. The method of claim 5, wherein the short-range wireless communication technology comprises at least one of: a near field communication (NFC) technology, a ZigBee technology, or a Bluetooth communication technology.

7. The method of claim 1, further comprising:
determining second data in the data to be migrated; and
transmitting the second data to the terminal.

8. A method for migrating data, comprising:
establishing a communication connection to a terminal;
receiving first data carrying first decryption information;
acquiring second decryption information; and
analyzing the first data when detecting that the second decryption information matches the first decryption information.

9. The method of claim 8, further comprising:
receiving second data; and
analyzing the second data.

10. The method of claim 8, wherein establishing the communication connection to the terminal comprises:
acquiring a hotspot identity of a wireless hotspot and password information corresponding to the hotspot identity, by scanning a two-dimensional code containing the hotspot identity of the wireless hotspot and the password information corresponding to the hotspot identity displayed on a display interface of the terminal; and
establishing the communication connection based on the hotspot identity and the password information.

11. The method of claim 8, wherein establishing the communication connection to the terminal comprises:
establishing the communication connection to the terminal based on a short-range wireless communication technology.

12. The method of claim 11, wherein the short-range wireless communication technology comprises at least one of: a near field communication (NFC) technology, a ZigBee technology, or a Bluetooth communication technology.

13. A terminal, comprising:
at least one processor; and
a computer readable storage, coupled to the at least one processor and storing at least one computer executable instruction thereon which, when executed by the at least one processor, causes the at least one processor to carry out actions, comprising:
establishing a communication connection to a terminal;
determining first data in data to be migrated; and
transmitting the first data carrying first decryption information to the terminal, the first decryption information being configured to be matched with second decryption information acquired by the terminal.

14. The terminal of claim 13, wherein the at least one processor configured to carry out transmitting the first data carrying the first decryption information to the terminal is configured to carry out actions, comprising:
acquiring the first decryption information pre-stored; and
transmitting the first data carrying the first decryption information pre-stored to the terminal.

15. The terminal of claim 13, wherein the at least one processor configured to carry out transmitting the first data carrying the first decryption information to the terminal is configured to carry out actions, comprising:
displaying a decryption information setting interface on a display interface;
acquiring the first decryption information inputted via the display interface; and
transmitting the first data carrying the first decryption information to the terminal.

16. The terminal of claim 13, wherein the at least one processor configured to carry out establishing the communication connection to the terminal is configured to carry out actions, comprising:
displaying a two-dimensional code containing a hotspot identity of a wireless hotspot and password information corresponding to the hotspot identity on a display interface, scanned by the terminal to acquire the hotspot identity and the password information; and
establishing the communication connection to the terminal based on the hotspot identity and the password information.

17. The terminal of claim 13, wherein the at least one processor configured to carry out establishing the communication connection to the terminal is configured to carry out actions, comprising:
establishing the communication connection to the terminal based on a short-range wireless communication technology.

18. The terminal of claim 17, wherein the short-range wireless communication technology comprises at least one of: a near field communication (NFC) technology, a ZigBee technology, or a Bluetooth communication technology.

19. The terminal of claim 13, wherein the at least one processor is further configured to carry out actions, comprising:
determining second data in the data to be migrated; and
transmitting the second data to the terminal.
